(19) United States
(12) Patent Application Publication
(10) Pub. No.: US 2013/0057591 A1
(43) Pub. Date: Mar. 7, 2013

(54) WIRELESS COMMUNICATION APPARATUS, PROJECTOR APPARATUS, WIRELESS COMMUNICATION SYSTEM, AND WIRELESS COMMUNICATION METHOD EACH FOR USE IN WIRELESS LAN

(71) Applicant: Norimitsu SUGIYAMA, Osaka (JP)

(72) Inventor: Norimitsu SUGIYAMA, Osaka (JP)

(21) Appl. No.: 13/601,032

(22) Filed: Aug. 31, 2012

(30) Foreign Application Priority Data
Sep. 2, 2011 (JP) 2011-191326
Aug. 29, 2012 (JP) 2012-188896

(51) Int. Cl. H04B 7/14; H04W 84/12; G09G 5/00

(52) U.S. Cl. 345/671; 370/315

(57) ABSTRACT

A wireless communication apparatus is for use in a wireless LAN, and performs wireless communication between access point apparatuses each having a function of a wireless LAN relay. A network identification information storage unit stores predetermined network identification information indicating that the wireless communication apparatus belongs to the wireless LAN, and an access point apparatus information generating unit generates access point apparatus identification information from information unique to an access point apparatus. An SSID generating unit generates an SSID including the network identification information and the access point apparatus identification information, and a wireless transmitting and receiving unit receives a probe request signal and transmit a probe response signal including the SSID in response to the probe request signal.

### BACKGROUND ART

1. TECHNICAL FIELD

The technical field is a wireless communication apparatus, a projector apparatus, a wireless communication system, and a wireless communication method each for use in a wireless LAN, and more particularly to a technique for wireless communication between wireless LAN access point apparatuses.

2. Description of the Related Art

In recent years, a wireless LAN (Local Area Network) complying with the IEEE 802.11 standard has been popular. A wireless LAN includes access point apparatuses (APs: Access Points) of the wireless LAN and wireless terminal apparatuses (STAB: STAtions), and each wireless terminal apparatus is connected to the access point apparatuses in infrastructure mode. A network configured by the access point apparatuses is identified by an SSID (Service Set Identifier). In addition, in order to extend a wireless LAN area, there is a method of allowing each access point apparatus to operate as a relay apparatus for wireless communication and to perform wireless communication between a plurality of access point apparatuses (See, for example, Patent Document 1). At this time, there are a case in which an SSID is set to be common on the extended wireless LAN and a case in which different SSIDs are set.

For wireless communication between access point apparatuses, a user registers the MAC (Media Access Control) address of an access point apparatus which is a communication counterpart, and registers security (an encryption scheme and an encryption key) common between both of the access point apparatuses. In addition, of the wireless LAN connection settings, for an encryption scheme and an encryption key, there is an automation method (See, for example, Patent Document 2). However, even in this method, the user needs to register the MAC address of a communication counterpart. Namely, the user manually performs wireless LAN connection settings for each access point apparatus.

A connection method for establishing wireless communication between access point apparatuses according to the prior art will be described below using FIG. 22. FIG. 22 is a flowchart showing a wireless communication connection process between wireless LAN access point apparatuses by a wireless LAN connection method according to the prior art.

First of all, the user performs wireless LAN connection settings. Specifically, in step S101 of FIG. 22, the user inputs the MAC address of a communication counterpart with an input unit, and a requesting access point apparatus registers the MAC address.

In step S102, the requesting access point apparatus transmits a probe request frame with the MAC address thereof as a source address. In step S112, a responding access point apparatus receives the probe request frame and detects the MAC address of the source. In step S113, the responding access point apparatus transmits a probe response frame with the MAC address of a requesting access point apparatus as a destination address, and the MAC address of the responding access point apparatus as the source address.

In step S103, the requesting access point apparatus detects the MAC address of the responding access point apparatus. Then, in step S104, the requesting access point apparatus checks whether the detected MAC address is the same as the registered MAC address. If it is determined that the detected MAC address is the registered MAC address, then a wireless communication connection between the access point apparatuses where security is ensured is established (step S105).

By the access point apparatuses performing their respective probe request processes described above, a wireless communication connection with the registered access point apparatus is established.

Documents related to the disclosures are as follows:
Patent Document 1: Japanese patent laid-open publication No. 2006-186526; and
Patent Document 2: Japanese patent laid-open publication No. 2006-050372.

As described above, in order to establish a wireless communication connection between access point apparatuses, the user needs to manually perform wireless LAN connection settings for each access point apparatus. Specifically, the user manually inputs a MAC address, an encryption scheme, and an encryption key for each access point apparatus. However, the operation of performing manual input of the above-described information on all access point apparatuses that perfor in communication is very cumbersome work.

### SUMMARY

In one general aspect, there is provided a wireless communication apparatus for use in a wireless LAN, that performs wireless communication between a plurality of access point apparatuses each having a function of a wireless LAN relay. The wireless communication apparatus includes a network identification information storage unit, an access point apparatus information generating unit, an SSID generating unit, and a wireless transmitting and receiving unit. The network identification information storage unit stores predetermined network identification information indicating that the wireless communication apparatus belongs to the wireless LAN, and the access point apparatus information generating unit generates access point apparatus identification information from information unique to an access point apparatus. The SSID generating unit generates an SSID including the network identification information and the access point apparatus identification information, and the wireless transmitting and receiving unit receives a probe request signal and transmits a probe response signal including the SSID in response to the probe request signal.

### BRIEF DESCRIPTION OF THE DRAWINGS

These and other objects and features of the disclosure will become clear from the following description taken in conjunction with the embodiments thereof with reference to the accompanying drawings throughout which like parts are designated by like reference numerals, and in which:

FIG. 1 is a perspective view showing a configuration of a wireless LAN system according to a first embodiment;

FIG. 2 is a block diagram showing a configuration of access point apparatuses 10 (101, 102, and 103) of FIG. 1;

FIG. 3 is a flowchart showing a wireless communication connection process between the access point apparatuses 101, 102, and 103 of FIG. 1;

FIG. 4 is a flowchart showing an SSID generation process (step S11), which is a subroutine of FIG. 3;

FIG. 5 is a structure diagram showing a configuration of a probe request MAC frame complying with IEEE 802.11, which is communicated between access point apparatuses to establish a wireless communication connection in the wireless LAN system;

FIG. 6 is a structure diagram showing a configuration of a probe response MAC frame complying with IEEE 802.11, which is communicated between the access point apparatuses to establish a wireless communication connection in the wireless LAN system;

FIG. 7A is a table showing an example of an SSID list 31 of the access point apparatus 101 of FIG. 1;

FIG. 7B is a table showing an example of an SSID list 31 of the access point apparatus 102 of FIG. 1;

FIG. 7C is a table showing an example of an SSID list 31 of the access point apparatus 103 of FIG. 1;

FIG. 8A is a table showing an example of a wireless communication list between access point apparatuses, which is stored in the access point apparatus 101 of FIG. 1;

FIG. 8B is a table showing an example of a wireless communication list between access point apparatuses, which is stored in the access point apparatus 102 of FIG. 1;

FIG. 8C is a table showing an example of a wireless communication list between access point apparatuses, which is stored in the access point apparatus 103 of FIG. 1;

FIG. 9 is a block diagram showing a configuration of a wireless terminal apparatus 2 according to first and second embodiments;

FIG. 10 is a flowchart showing a wireless communication connection process performed by the wireless terminal apparatus 2 of FIG. 9;

FIG. 11 is a table showing an example of an SSID list 31 of the wireless terminal apparatus 2 of FIG. 9;

FIG. 12 is a table showing an example of an access point apparatus list 33 of the wireless terminal apparatus 2 of FIG. 9;

FIG. 13 is a perspective view showing a configuration of a wireless LAN system according to the second embodiment;

FIG. 14 is a block diagram showing a configuration of projector apparatuses 1 (1a and 1b) having mounted thereon a wireless LAN access point apparatus of FIG. 13;

FIG. 15 is a flowchart showing a wireless communication connection process between access point apparatuses, which is performed by a projector apparatus 1 of FIG. 14;

FIG. 16A is a table showing an example of an SSID list of the projector apparatus 1a of FIG. 14;

FIG. 16B is a table showing an example of an SSID list of the projector apparatus 1b of FIG. 14;

FIG. 17A is a table showing an example of a wireless communication list 32 between access point apparatuses, which is stored in the projector apparatus 1a of FIG. 14;

FIG. 173 is a table showing an example of a wireless communication list 32 between access point apparatuses, which is stored in the projector apparatus 1b of FIG. 14;

FIG. 18 is a flowchart showing a wireless communication connection process performed by a wireless terminal apparatus 2 of FIG. 13;

FIG. 19 is a table showing an example of an SSID list 31 of the wireless terminal apparatus 2 of FIG. 13;

FIG. 20 is a table showing an example of a projector apparatus list 34 of the wireless terminal apparatus 2 of FIG. 13;

FIG. 21 is a front view showing an example of a projector apparatus selection screen displayed on a display 254 of the wireless terminal apparatus 2 of FIG. 13; and

FIG. 22 is a flowchart of a wireless communication connection process between access point apparatuses according to the prior art.

### DETAILED DESCRIPTION OF THE EMBODIMENTS

Embodiments will be described below with reference to the drawings. It is noted that in the following embodiments like components are denoted by the same reference characters.

### First Embodiment

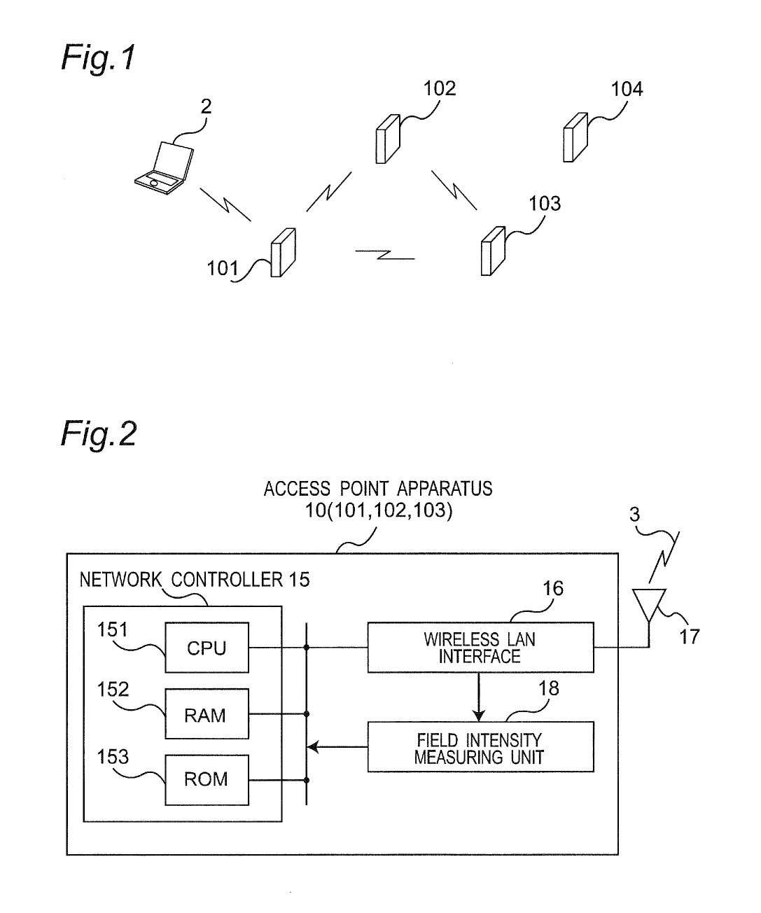

FIG. 1 is a perspective view showing a configuration of a wireless LAN system according to a first embodiment. Referring to FIG. 1, the wireless LAN system is configured to include four access point apparatuses 101, 102, 103, and 104 and a wireless terminal apparatus 2. In this case, the access point apparatuses 101, 102, and 103 are access point apparatuses that establish a wireless LAN connection according to the present embodiment, and are connected to each other by wireless communication between the access point apparatuses and configure a wireless LAN, which is a wireless network. The access point apparatus 104 is an access point apparatus having a configuration according to the prior art. The wireless terminal apparatus 2 is connected to the access point apparatus 101 in infrastructure mode and is connected to the wireless LAN.

FIG. 2 is a block diagram showing a configuration of the access point apparatuses 101, 102, and 103 (collectively denoted by reference character 10) of FIG. 1. Referring to FIG. 2, each access point apparatus 10 according to the present embodiment is configured to include a network controller 15 composed of a CPU (Central Processing Unit) 151, a RAM (Random Access Memory) 152, and a ROM (Read Only Memory) 153; a wireless LAN interface 16 that transmits a radio transmitting signal for use in a wireless LAN connection and receives a radio received signal; an antenna 17; and a field intensity measuring unit 18. The ROM 153 stores a program for a wireless communication connection process between access point apparatuses, and data required to execute the program. In this case, the wireless LAN interface 16 is configured to include a wireless transmitter circuit (wireless transmitting unit or wireless transmitting means) for use in a wireless LAN and a wireless receiver circuit (wireless receiving unit or wireless receiving means) for use in a wireless LAN. A transmitting signal to be transmitted from the access point apparatus 10 is radiated through the wireless LAN interface 16 and the antenna 17 so as to be superimposed on a radio wave 3. A received signal, which is received by the access point apparatus 10, superimposed on a radio wave 3 is inputted to the network controller 15 through the antenna 17 and the wireless LAN interface 16. The received signal is inputted to the field intensity measuring unit 18 from the wireless LAN interface 16, and the field intensity measuring unit 18 outputs the value of the field intensity of the received signal to the network controller 15.

The ROM 153 of each of the access point apparatuses 101, 102, and 103 stores a MAC address and an encryption scheme that can be supported thereby. In this case, the MAC addresses are as follows. The MAC address of the access point apparatus 101 is “12345611111a”, the MAC address of the access point apparatus 102 is “12345622222b”, the MAC address of the access point apparatus 103 is “12345633333c”, and the MAC address of the access point apparatus 104 is “12345644444d”. In addition, the encryption schemes that can be supported are as follows. The encryption scheme that can be supported by the access point apparatus 101 is “WEP”, the encryption schemes that can be supported by the access point apparatus 102 are “WEP, TKIP, and AES”, the encryption schemes that can be supported by the access point apparatus 103 are “WEP, TKIP, and AES”, and the encryption schemes that can be supported by the access point apparatus 104 are “WEP, TKIP, and AES”.

Further, the ROM 153 in each of the access point apparatuses 101, 102, and 103 according to the present embodiment stores network identification information. In this case, the network identification information is “ABCD”.

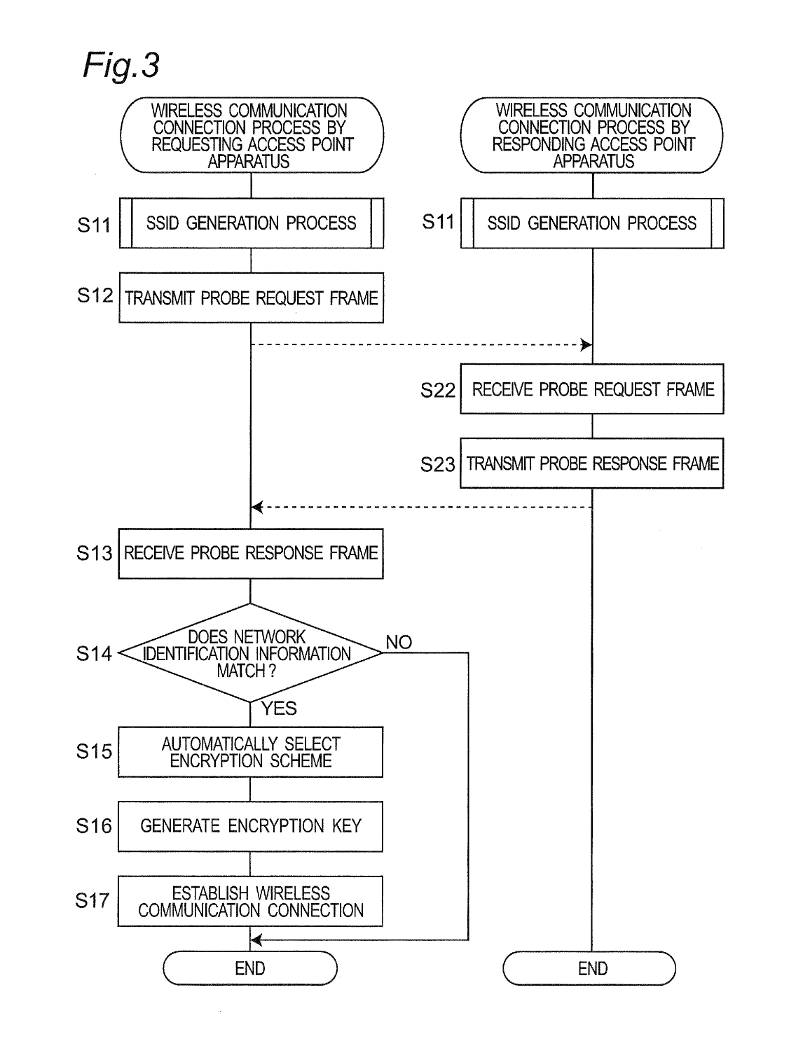

FIG. 3 is a flowchart showing a wireless communication connection process between the access point apparatuses 101, 102, and 103 of FIG. 1. Referring to FIG. 3, first of all, each access point apparatus performs an SSID generation process (step S11).

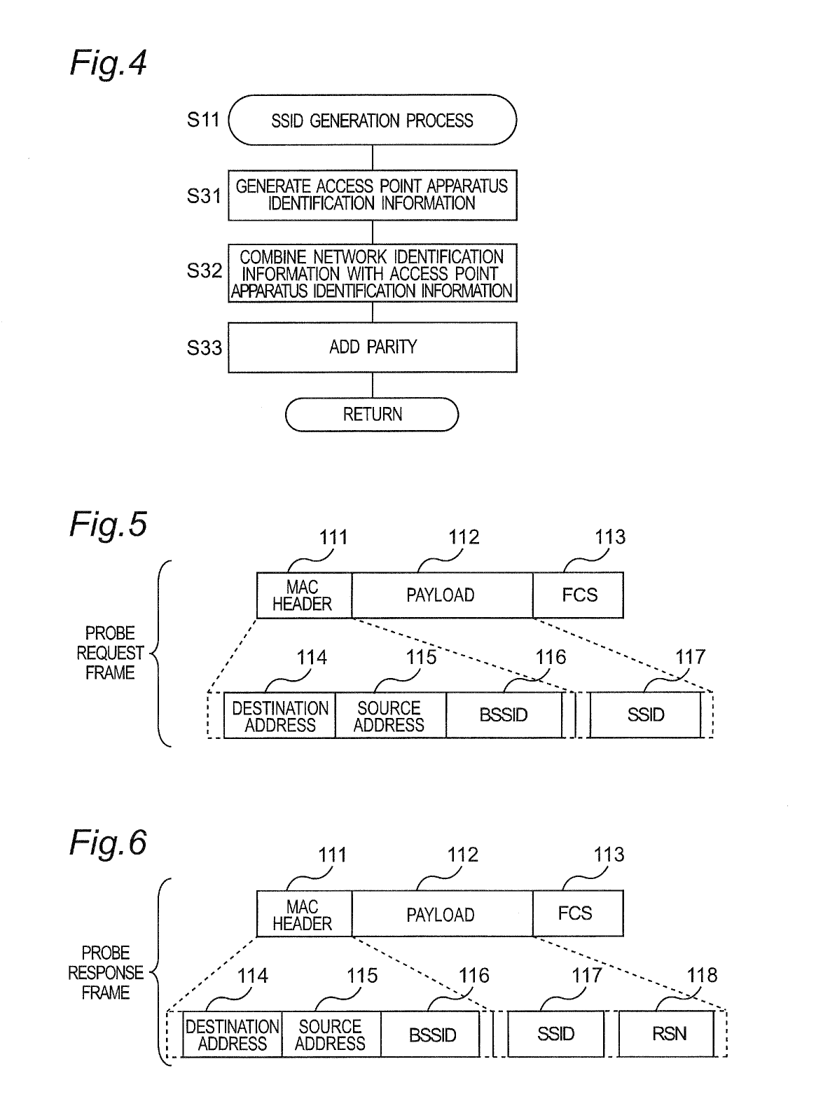

FIG. 4 is a flowchart showing an SSID generation process (step S11), which is a subroutine of FIG. 3. In step S31 of FIG. 4, the access point apparatus generates identification information unique thereto. Specifically, the access point apparatus generates access point apparatus identification information based on information related thereto. As the related information, the access point apparatus uses a code such as the MAC address or serial number thereof. Identification information to be generated may be the same as the original code or may be a part of the original code. In addition, random numbers may be generated using the original code as an input and a code of the values of the random numbers or a part thereof may be used as identification information. In this case, a code of the lower four digits of the MAC address code is used as access point apparatus identification information. For example, the identification information of the access point apparatus 101 is “111a”.

Then, in step S32 of FIG. 4, the access point apparatus combines the network identification information with the access point apparatus identification information. In step S33, the access point apparatus adds parity, by which an SSID code is generated. For example, the parity of the access point apparatus 101 is “FE”. In this case, the SSIDs of the access point apparatuses 101, 102, and 103 are as follows. The SSID of the access point apparatus 101 is “ABCD111aFE”, the SSID of the access point apparatus 102 is “ABCD222b02”, and the SSID of the access point apparatus 103 is “ABCD333c06”.

The process, which is performed from when the access point apparatus 101 makes a probe request to when a wireless communication connection between access point apparatuses is established, will be described below.

In step S12 of FIG. 3, the requesting access point apparatus 101 transmits a probe request frame shown in FIG. 5. FIG. 5 is a structure diagram showing a configuration of an IEEE 802.11 probe request MAC frame. Referring to FIG. 5, the MAC frame includes a MAC header 111, a payload 112, and an FCS (Frame Check Sequence) 113. The MAC header 111 includes a destination address field 114, a source address field 115, and a BSS (Basic Service Set) ID field 116. In the source address field 115 is stored the MAC address “12345611111a” of the source access point apparatus. In addition, in an SSID field 117 of the payload 112 is stored “Null”.

When the responding access point apparatus 102 receives a signal of the probe request MAC frame (step S22), the access point apparatus 102 performs a responding process. At this time, it is assumed that the access point apparatus 102 has already generated the above-described SSID in an SSID generation process of FIG. 4. In step S22, the access point apparatus 102 detects the MAC address “12345611111a” of the source from the received signal.

In step S23 of FIG. 3, the access point apparatus 102 transmits a probe response frame shown in FIG. 6. FIG. 6 is a structure diagram showing a configuration of a probe response MAC frame complying with IEEE 802.11, which is communicated between the access point apparatuses to establish a wireless communication connection in the wireless LAN system. Referring to FIG. 6, a destination address field 114 is “12345611111a”, a source address field 115 is “12345622222b”, a BSSID field 116 is “12345622222b”, and an SSID field 117 is “ABCD222b02”. In an RSN (Robust Security Network) field 118 in a payload 112 is stored the information “AES” as the most powerful encryption scheme that can be supported by the access point apparatus 102.

In step S13 of FIG. 3, the access point apparatus 101 receives the probe response frame and detects the MAC address “12345622222b” of the source, the SSID “ABCD222b02”, and the encryption scheme “AES” that can be supported by the access point apparatus 102, from the received signal.

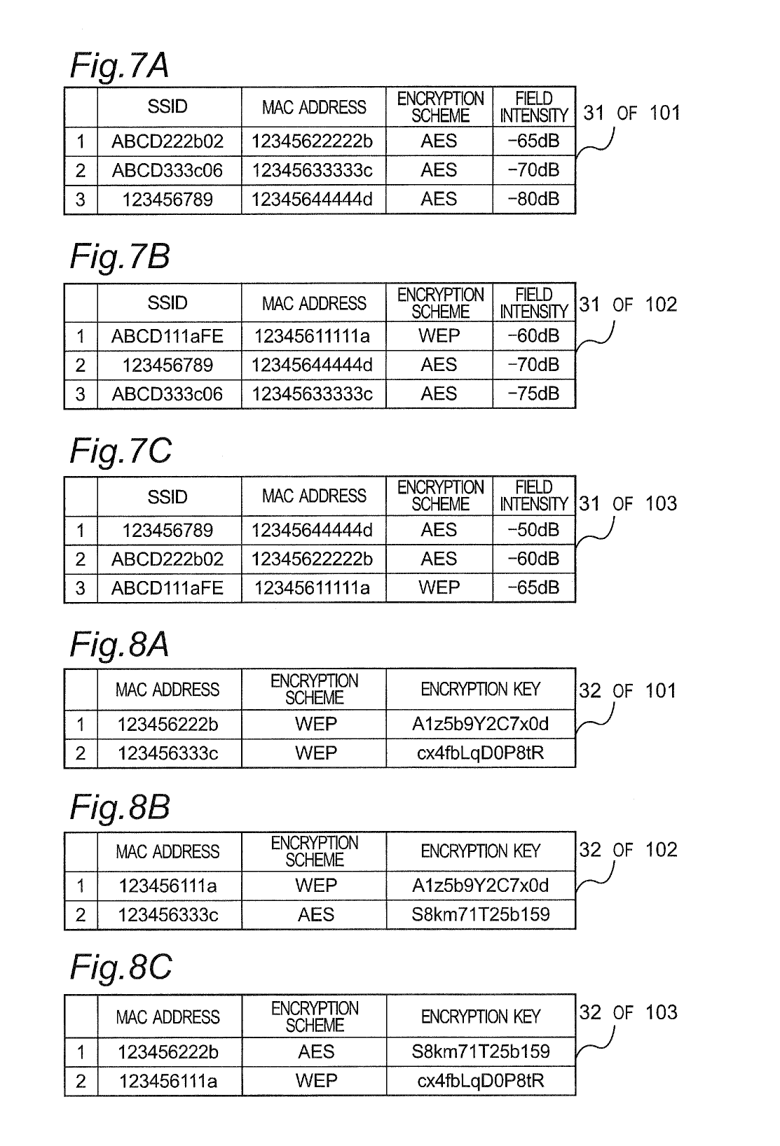

FIG. 7A is a table showing an example of an SSID list 31 of the access point apparatus 101 of FIG. 1, FIG. 7B is a table showing an example of an SSID list 31 of the access point apparatus 102 of FIG. 1, and FIG. 7C is a table showing an example of an SSID list 31 of the access point apparatus 103 of FIG. 1. It is noted that the SSID lists 31 are stored in the RAMs 152 of the respective access point apparatuses 101, 102, and 103.

The requesting access point apparatus 101 registers the information detected in step S13 of FIG. 3, in the SSID list 31. Referring to FIGS. 7A, 7B and 7C, a MAC address and an encryption scheme are registered for each SSID. In addition, the field intensity of a received radio wave, which is measured by the field intensity measuring unit 18 is also registered in the SSID list 31. FIG. 7A showing the SSID list 31 of the access point apparatus 101 shows that the field intensity for when the access point apparatus 101 receives a signal from the access point apparatus 102 is “−65 dB”. In addition, FIG. 7A also shows the cases in which the access point apparatus 101 receives signals from the access point apparatus 103 and the access point apparatus 104. The SSID of the access point apparatus 103 is the above-described “ABCD333c06” and the SSID of the access point apparatus 104 according to the prior art is “123456789”. Received signals to be registered in the SSID list 31 are sorted in descending order of field intensity and registered.

In step S14 of FIG. 3, the requesting access point apparatus 101 checks whether the network identification information included in the detected SSID matches the stored network identification information. If the two pieces of network identification information match, then the access point apparatus 101 performs a parity check of the SSID code. For example, for the access point apparatuses whose SSIDs of FIG. 7A are “ABCD222b02” and “ABCD333c06”, their pieces of network identification information match the stored network identification information and the parity check is OK. On the other hand, for the access point apparatus whose SSID is “123456789”, its network identification information does not match the stored network identification information. For those access point apparatuses with parity check OK, the access point apparatus 101 continues the connection process and proceeds to the next step S15.

In step S15, the access point apparatus 101 automatically selects an encryption scheme for wireless communication with the access point apparatus 102. For the encryption scheme, the access point apparatus 101 selects an encryption scheme with the highest security level from among the encryption schemes that can be supported by both of the access point apparatuses. Since the access point apparatus 101 can support WEP and the access point apparatus 102 can support WEP, TKIP, and AES, the access point apparatus 101 automatically selects “WEP” that can be supported by both of the access point apparatuses.

In step S16, the access point apparatus 101 generates an encryption key for communication with the access point apparatus 102. The encryption key is generated by a predetermined encryption key generation algorithm, based on the SSID codes of both of the access point apparatuses. For example, the encryption key generation algorithm generates an encryption key by generating random numbers using, as an input, the access point apparatus identification information of both of the access point apparatuses. In this case, it is assumed that using “111a” and “222b” as an input, the random numbers “A1z5b9Y2C7×0d” are generated.

FIG. 8A is a table showing an example of a wireless communication list 32 between access point apparatuses, which is stored in the access point apparatus 101 of FIG. 1, FIG. 8B is a table showing an example of a wireless communication list 32 between access point apparatuses, which is stored in the access point apparatus 102 of FIG. 1, and FIG. 8C is a table showing an example of a wireless communication list 32 between access point apparatuses, which is stored in the access point apparatus 103 of FIG. 1. It is noted that the wireless communication lists 32 are stored in the RAMs 152 of the respective access point apparatuses 101, 102, and 103. Referring to FIGS. 8A, 8B, and 8C, a MAC address, an encryption scheme, and an encryption key are registered for each communication counterpart. In step S17, based on the wireless communication list 32 between access point apparatuses, the access point apparatus 101 establishes a wireless communication connection with the access point apparatus 102 using an encryption scheme and an encryption key which are described in the wireless communication list 32.

As described above, according to the present embodiment, the process, from when the access point apparatus 101 makes a probe request to when a wireless communication connection is established, is described. The process, from when the access point apparatuses 102 and 103 make a probe request to when a connection is established, is also the same as above. Referring to FIGS. 8A, 8B, and 8C, for a pair of access point apparatuses performing wireless communication, the same encryption scheme is used and the same encryption key is generated.

When the number of access point apparatuses that can be connected to a certain access point apparatus is limited, such a number of access point apparatuses that can be registered are selected in turn in descending order of field intensity from among access point apparatuses registered in an SSID list 31, and the selected access point apparatuses are registered in a wireless communication list 32 between access point apparatuses.

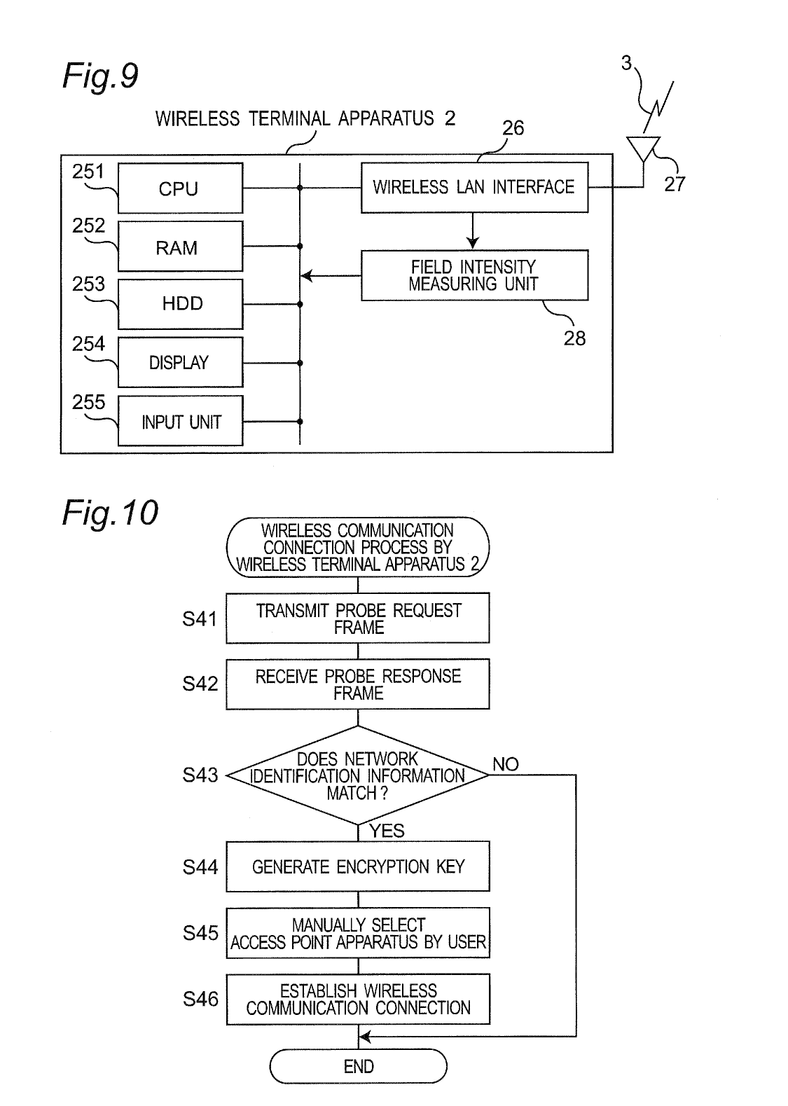

FIG. 9 is a block diagram showing a configuration of a wireless terminal apparatus 2 according to the first and second embodiments. With reference to FIG. 9, a wireless connection process by the wireless terminal apparatus 2 will be described.

Referring to FIG. 9, the wireless terminal apparatus 2 is configured to include a CPU 251, a RAM 252, an HDD (Hard Disk Drive) 253, a display 254, an input unit 255 such as a keyboard and a mouse, a wireless LAN interface 26, an antenna 27, and a field intensity measuring unit 28. In this case, the wireless LAN interface 26 is configured in the same manner as the wireless LAN interface 16 and is configured to include a wireless transmitter circuit (wireless transmitting unit or wireless transmitting means) for use in a wireless LAN and a wireless receiver circuit (wireless receiving unit or wireless receiving means) for use in a wireless LAN.

On the HDD 253 are installed wireless settings for connecting the wireless terminal apparatus 2 to the access point apparatuses 10 by a wireless LAN, and a program, which is communication software. The program has the code “ABCD” described therein as network identification information. The program is loaded into the RAM 252 and executed upon startup of the wireless terminal apparatus 2. A transmitting signal is radiated through the wireless LAN interface 26 and the antenna 27 so as to be superimposed on a radio wave 3. A received signal superimposed on a radio wave 3 is inputted to the RAM 252 through the antenna 27 and the wireless LAN interface 26. The received signal is inputted to the field intensity measuring unit 28 from the wireless LAN interface 26, and the field intensity measuring unit 28 outputs the value of the field intensity of the received signal to the RAM 252.

FIG. 10 is a flowchart showing a wireless communication connection process performed by the wireless terminal apparatus 2 of FIG. 9. In step S41 of FIG. 10, the wireless terminal apparatus 2 transmits a probe request frame. An access point apparatus having received a signal of the probe request frame transmits a signal of a probe response frame. Then, in step S42, the wireless terminal apparatus 2 receives the signal of the probe response frame and detects the MAC address, SSID, and encryption scheme of the source from the received signal.

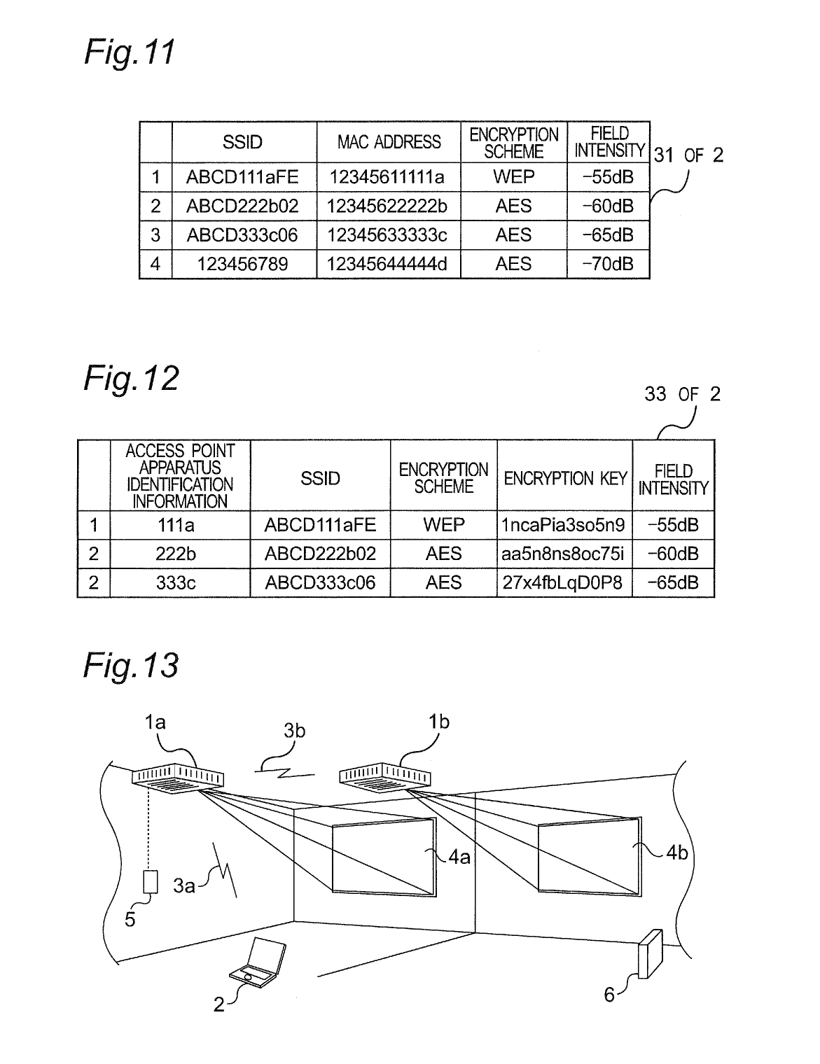

The wireless terminal apparatus 2 registers the information detected in step S42 of FIG. 10 in an SSID list 31. FIG. 11 is a table showing an example of the SSID list 31 of the wireless terminal apparatus 2 of FIG. 9. Referring to FIG. 11, a MAC address and an encryption scheme are registered in the SSID list 31 for each SSID. In addition, the field intensity of a received radio wave, which is measured by the field intensity measuring unit 28, is also registered. The pieces of information on the access point apparatuses 101, 102, 103, and 104 are arranged in descending order of field intensity.

In step S43 of FIG. 10, the wireless terminal apparatus 2 checks whether network identification information included in the detected SSID matches the network identification information described in the program. If the pieces of network identification information match, then the wireless terminal apparatus 2 performs a parity check of the SSID code. For the access point apparatuses whose SSIDs of FIG. 11 are “ABCD111aFE”, “ABCD222b02”, and “ABCD333c06”, their pieces of network identification information match the network identification information described in the program and the parity check is OK. On the other hand, for the access point apparatus whose SSID is “123456789”, its network identification information does not match the network identification information described in the program. For those access point apparatuses with parity check OK, the wireless terminal apparatus 2 continues the connection process and proceeds to the next step S44.

In step S44 of FIG. 10, the wireless terminal apparatus 2 generates an encryption key. In this case, the encryption key is random numbers which are generated using the SSID code as a seed. FIG. 12 is a table showing an example of an access point apparatus list 33 of the wireless terminal apparatus 2 of FIG. 9. Referring to FIG. 12, in the access point apparatus list 33 are registered pieces of access point apparatus identification information whose pieces of network identification information match the network identification information described in the program, SSIDs, encryption schemes, encryption keys, and field intensities. The wireless terminal apparatus 2 extracts display data from the access point apparatus list 33 and displays an access point apparatus list on the display 254.

In step S45 of FIG. 10, the user selects an access point apparatus to perform communication, from among the access point apparatuses displayed on the display 254, using the input unit 255. When there are a plurality of access point apparatuses to perform communication, the wireless terminal apparatus 2 selects one of the access point apparatuses each having the highest field intensity and uses the selected access point apparatus as a communication counterpart to connect in infrastructure mode.

Then, in step S46, the wireless terminal apparatus 2 establishes a wireless communication connection with the access point apparatus, which is the communication counterpart in infrastructure mode. In this case, the wireless terminal apparatus 2 is connected to the access point apparatus 101 in infrastructure mode. Since the access point apparatus 101 is connected to the access point apparatuses 102 and 103, the wireless terminal apparatus 2 can communicate with the access point apparatuses 102 and 103 through the access point apparatus 101.

As described above, according to the present embodiment, by including network identification information and access point apparatus identification information in an SSID, a wireless communication connection process between access point apparatuses is performed without the user's manually performing connection settings, and this leads to more easily establishing of a wireless communication connection between wireless LAN access point apparatuses, as compared with the prior art.

### Second Embodiment

FIG. 13 is a perspective view showing a configuration of a wireless LAN system according to a second embodiment. The wireless LAN system according to the present embodiment is configured to include two projector apparatuses 1a and 1b, a wireless terminal apparatus 2, and an access point apparatus 6. In this case, the projector apparatuses 1a and 1b include an optical projector unit that includes a light source 12, a liquid crystal panel 3, and a projector lens 14 which will be described in detail later, and that, for example, enlarges and projects an image of wirelessly received image data. The projector apparatuses 1a and 1b further have a wireless LAN access point apparatus function. The projector apparatuses 1a and 1b perform wireless communication between access point apparatuses by performing transmission and reception of a radio wave 3b with each other. The wireless terminal apparatus 2 is, for example, a notebook personal computer and transmits and receives a radio wave 3a and is connected to the projector apparatus 1a in infrastructure mode. The projector apparatuses 1a and 1b acquire information such as presentation documents from the wireless terminal apparatus 2 and project images of the information onto a screen 4a and a screen 4b, respectively. The power to each of the projector apparatuses 1a and 1b is turn on and off by an operating unit 5. The wireless terminal apparatus 2 is placed near the projector apparatus 1a. In addition, the access point apparatus 6 is an access point apparatus according to the prior art.

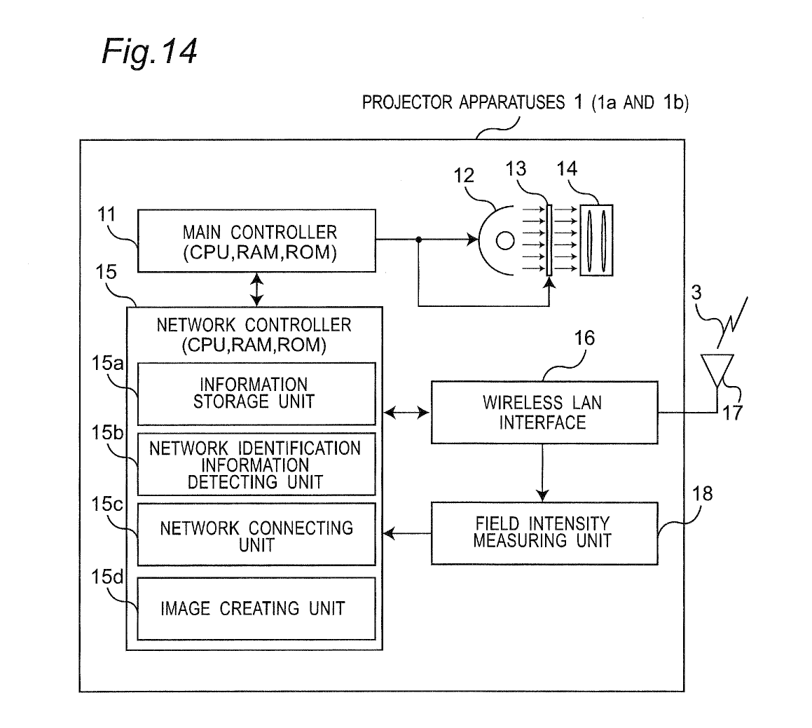

FIG. 14 is a block diagram showing a configuration of the projector apparatuses 1a and 1b (collectively denoted by reference character 1) having mounted thereon a wireless LAN access point apparatus of FIG. 13. Referring to FIG. 14, each projector apparatus 1 is configured to include a main controller 11 that performs control for the projector apparatus 1; a light source 12; a liquid crystal panel 13 that displays images; a projector lens 14 that enlarges and projects an image obtained by modulating light from the light source 12 by the liquid crystal panel 13; a network controller 15 that performs control for use in a wireless LAN; a wireless LAN interface 16 that transmits and receives radio signals; an antenna 17; and a field intensity measuring unit 18. In this case, the network controller 15 is configured to include a CPU 151, a RAM 152, a ROM 153, and the like, shown in FIG. 2. In addition, the network controller 15 is configured to include an information storage unit 15a that stores projector apparatus identification information for identifying predetermined network identification information and other projector apparatuses; a network information detecting unit 15b that detects the predetermined network identification information from a received signal; a network connecting unit 15c that performs settings required for wireless communication between access point apparatuses; and an image creating unit 15d. In this case, the image creating unit 15d creates an image from TCP/IP data received from the wireless terminal apparatus 2 through the wireless LAN interface 16 and the antenna 17.

The wireless terminal apparatus 2 has the same configuration as that of FIG. 9. The wireless terminal apparatus 2 is configured to include a CPU 251 which is core control means, a RAM 252 which is a main storage memory, an HDD 253, a display 254 which is display means, an input unit 255 such as a keyboard and a mouse, a wireless LAN interface 26, an antenna 27, and a field intensity measuring unit 28.

In this case, on the HDD 253 are installed in advance wireless settings for connecting the projector apparatus 1 to the wireless terminal apparatus 2 through a wireless LAN, and a program which is communication software (referred to as the wireless manager (WM)). The software can also be installed later. The program stores network identification information. When the wireless terminal apparatus 2 starts up, the program is loaded into the RAM 252 and executed. When the program is executed and the wireless terminal apparatus 2 is connected to the projector apparatus 1, the wireless terminal apparatus 2 generates image data and wirelessly transmits, as TCP/IP data, the image data to the projector apparatus 1 through the wireless LAN interface 26.

First of all, wireless communication between the projector apparatuses 1a and 1b will be described. The projector apparatuses 1a and 1b and the access point apparatus 6 store MAC addresses and encryption schemes that can be supported thereby. In this case, the MAC addresses are as follows. The MAC address of the projector apparatus 1a is “12345611111a”, the MAC address of the projector apparatus 1b is “12345622222b”, and the MAC address of the access point apparatus 6 is “12345644444d”. In addition, the encryption schemes that can be supported are as follows. The encryption scheme that can be supported by the projector apparatus 1a is “WEP”, the encryption schemes that can be supported by the projector apparatus 1b are “WEP, TKIP, and AES”, and the encryption schemes that can be supported by the access point apparatus 6 are “WEP, TKIP, and AES”. Further, the projector apparatuses 1a and 1b store network identification information. In this case, the network identification information is “ASCD”.

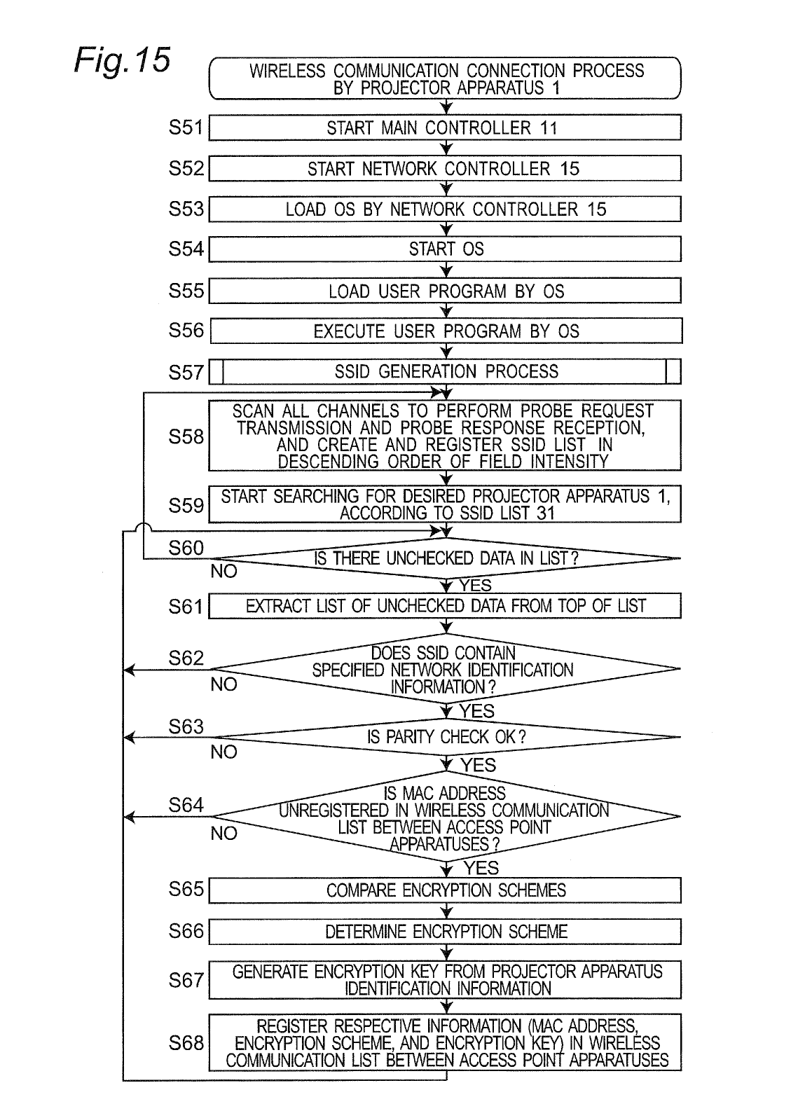

FIG. 15 is a flowchart showing a wireless communication connection process between access point apparatuses, which is performed by a projector apparatus 1 of FIG. 14. In this case, FIG. 15 shows the process up to the point where the projector apparatuses 1a and 1b are connected to each other, and shows a wireless communication connection process performed by a probe requesting projector apparatus 1.

Referring to FIG. 15, when the operating unit 5 turns on the power to the projector apparatus 1a and the projector apparatus 1b, in step S51, the main controller 11 starts. In step S52, the main controller 11 starts the network controller 15. In step S53, the network controller 15 loads an OS (Operating Systems) into the RAM from the ROM. In step S54, the OS starts. In step S55, the OS loads a user program into the RAM from the ROM. In step S56, the OS executes the user program.

Then, in step S57, the user program executed by the OS performs an SSID generation process. The SSID generation process is the same as that shown in the above-described FIG. 4 and thus description thereof is not repeated here. The generated SSIDs are as follows. The SSID of the projector apparatus 1a is “ABCD111aFE” and the SSID of the projector apparatus 1b is “ABCD222b02”. In this case, “ABCD” is common network identification information and “111a” and “222b” are the identification information of the projector apparatuses 1a and 1b, respectively. “FE” and “02” are parity. Then, in step S58, the probe requesting projector apparatus 1 performs wireless transmission and reception to search for projector apparatuses 1. The probe requesting projector apparatus 1 performs wireless transmission and reception through the network connecting unit 15c, the wireless LAN interface 16, the antenna 17, and a radio wave 3. The projector apparatus 1a and the projector apparatus 1b each perform a scanning process by transmitting a probe request frame to all channels (e.g., ch1 to ch11) and receiving probe response frames which are responses thereto, and create and register an SSID list. The probe request frames and the probe response frames are the same as those in the above-described FIGS. 5 and 6 and thus description thereof is not repeated here.

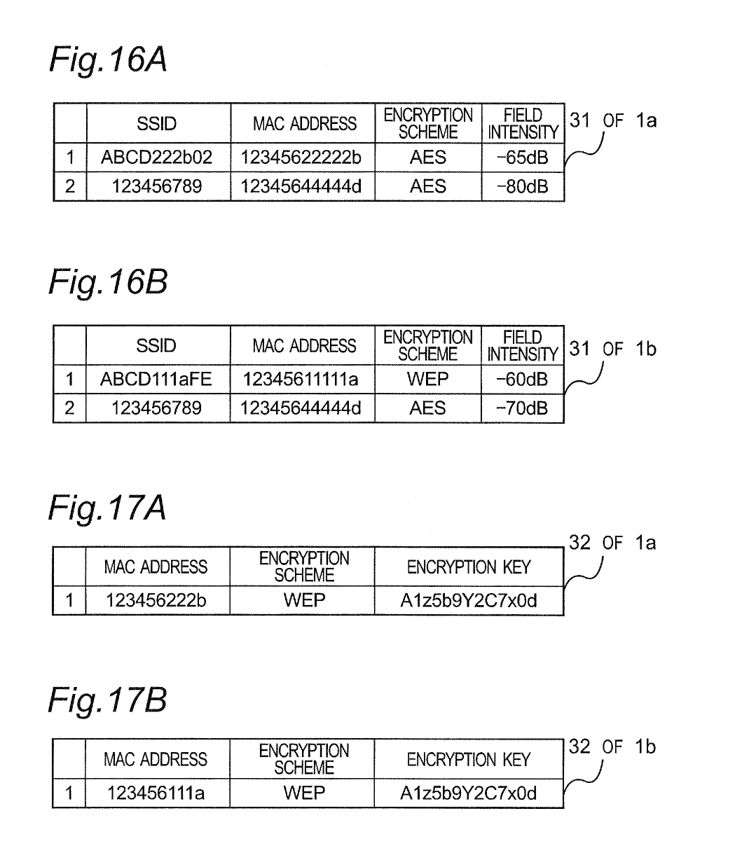

FIG. 16A is a table showing an example of the SSID list of the projector apparatus 1a of FIG. 14 and FIG. 16B is a table showing an example of the SSID list of the projector apparatus 1b of FIG. 14. Referring to FIGS. 16A and 16B, each SSID list includes the retrieved SSIDs, MAC addresses, encryption schemes, and field intensities, and the pieces of information are arranged in descending order of field intensity. In this case, the SSIDs, the MAC addresses, and the encryption schemes are obtained from probe response frames, and the field intensities are obtained by the field intensity measuring unit 18 measuring the field intensities of radio waves of radio signals including the probe response frames. As is apparent from FIG. 16A, the projector apparatus 1a receives radio signals including probe response frames from the projector apparatus 1b and the access point apparatus 6. In addition, as is apparent from FIG. 16B, the projector apparatus 1b receives radio signals including probe response frames from the projector apparatus 1a and the access point apparatus 6.

Then, in step S59 of FIG. 15, the projector apparatus 1 starts searching for a desired projector apparatus having network identification information, according to the SSID list created in step S58.

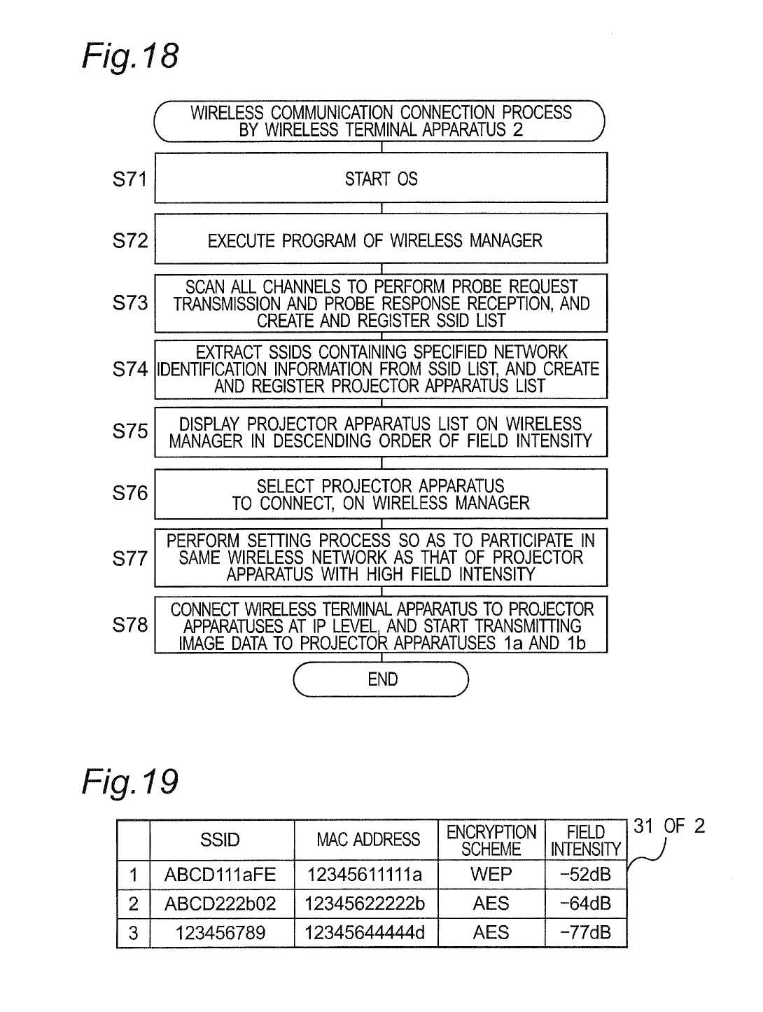

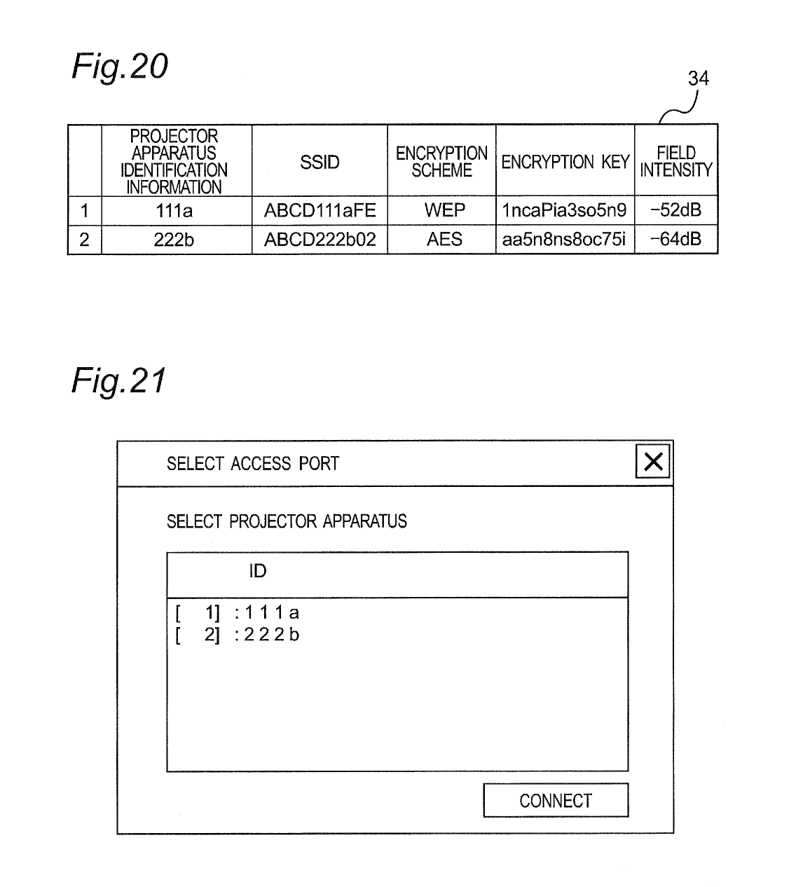

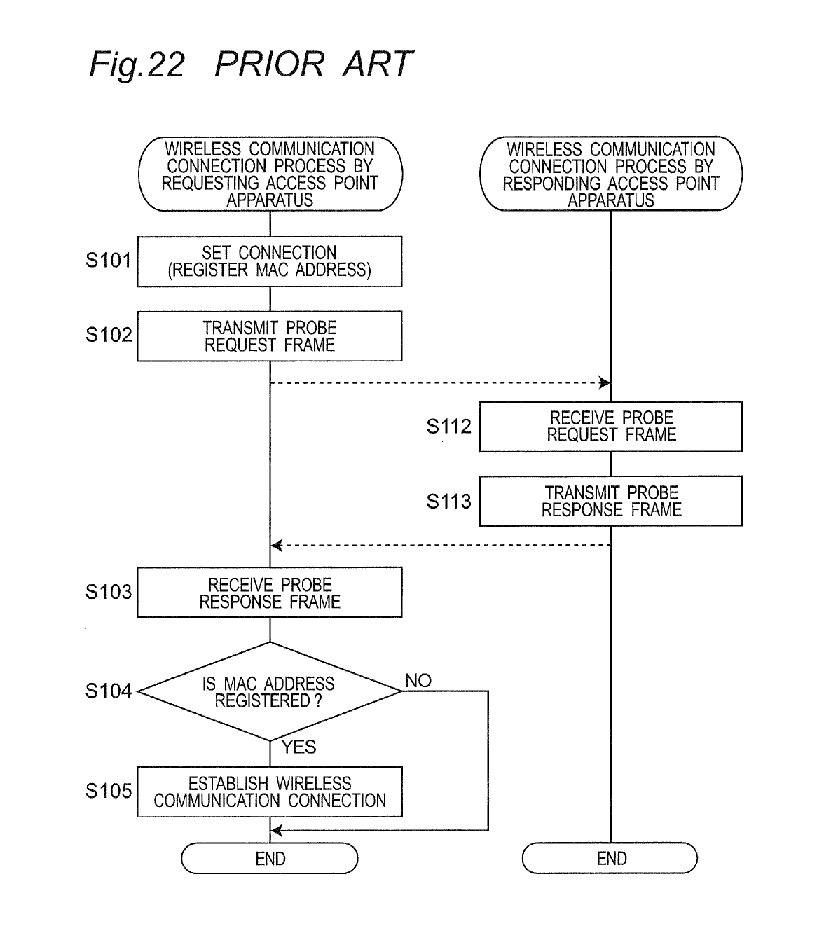

In step S60 of FIG. 15, the projector apparatus 1 determines whether there is SSID data to be checked in the SSID list. If there is SSID data to be checked (if “YES”), then in step S61, the network information detecting unit 15b extracts a list of unchecked SSID data from the top of the SSID list. In step S62, the network information detecting unit 15b determines whether or not an SSID includes the network identification information “ABCD”. If the SSID includes the network identification information “ABCD” (if “YES”), then in step S63, a checksum is calculated from the SSID and then the parity is determined. If the parity check is OK (if “YES”), then in step S64, it is determined whether the MAC address is already registered in a wireless communication list between access point apparatuses. Referring to FIGS. 17A and 17B, each wireless communication list between access point apparatuses includes the MAC address, encryption scheme, and encryption key of a projector apparatus 1 that performs wireless communication between access point apparatuses.

In step S64, if the MAC address is unregistered (if “YES”), then the projector apparatus 1 compares, in step S65, the encryption scheme thereof with the encryption scheme of a projector apparatus 1 which is the communication counterpart and determines, in step S66, an encryption scheme supported by both of the projector apparatuses 1. For example, by selecting a lower encryption scheme, an encryption scheme supported by both of the projector apparatuses 1 can be taken. Then, in step S67, the projector apparatus 1 sets, as an encryption key, random numbers which are generated using, as a seed, a character string obtained by combining the pieces of projector apparatus identification information or SSID character strings of both of the projector apparatuses 1. Then, in step S68, the projector apparatus 1 registers the MAC address, the encryption scheme (security), and the encryption key in the wireless communication list between access point apparatuses and returns to step S60.

FIG. 17A is a table showing an example of a wireless communication list 32 between access point apparatuses, which is stored in the projector apparatus 1a of FIG. 14, and FIG. 17B is a table showing an example of a wireless communication list 32 between access point apparatuses, which is stored in the projector apparatus 1b of FIG. 14. Referring to FIGS. 17A and 17B, a MAC address, an encryption scheme, and an encryption key are registered for each communication counterpart. The projector apparatus 1b is registered in the wireless communication list 32 of FIG. 17A. In addition, the projector apparatus 1a is registered in the wireless communication list 32 of FIG. 17B.

By this, the projector apparatus 1a and the projector apparatus 1b can perform wireless communication. In addition, by repeating steps S58 to S68, even if another projector apparatus starts up later on, wireless communication can be performed. Specifically, referring to FIG. 15, if NO in step S60 then the projector apparatus 1 returns to step S58 and repeats the processes in steps S58 and S59, and if NO in steps S62, S63, and S64 then the projector apparatus 1 returns to step S60 and repeats subsequent processes.

FIG. 18 is a flowchart showing a wireless communication connection process performed by the wireless terminal apparatus 2 of FIG. 13. Referring to FIG. 18, the operation up to the point where the wireless terminal apparatus 2 is connected to the projector apparatus 1a and the projector apparatus 1b and allows them to display the same image will be described.

In the wireless communication connection process of FIG. 18, when the power to the wireless terminal apparatus 2 is turned on, in step S71 the OS starts. Then, in step S72, when a program of wireless manager is executed, the program is loaded into the RAM 252 from the HDD 253, the wireless manager starts, and search operation starts. Specifically, the wireless terminal apparatus 2 starts a search for projector apparatuses 1 by radiating a radio wave 3 through the wireless LAN interface 26 and the antenna 27. First of all, in step S73, the wireless manager performs a scanning process by transmitting a probe request frame to all channels (e.g., ch1 to ch11) and receiving probe response frames which are responses thereto, and creates and registers an SSID list.

FIG. 19 is a table showing an example of an SSID list 31 of the wireless terminal apparatus 2 of FIG. 13. In this case, the SSID list 31 includes the retrieved SSIDs, MAC addresses, encryption schemes, and field intensities, and the pieces of information are arranged in descending order of field intensity. In this case, the SSIDs, the MAC addresses, and the encryption schemes are obtained from probe response frames, and the field intensities are obtained by the field intensity measuring unit 28 measuring the field intensities of radio waves of radio signals including the probe response frames. The pieces of information on the projector apparatus 1a, the projector apparatus 1b, and the access point apparatus 6 are arranged in descending order of field intensity.

Then, in step S74 of FIG. 18, the wireless terminal apparatus 2 searches for desired wireless projector apparatuses each having the network identification information “ABCD”, according to the SSID list created in step S73. If the wireless terminal apparatus 2 has detected SSIDs including the specified network identification information “ABCD”, then the wireless terminal apparatus 2 calculates checksums from SSID character strings and performs parity checks, by which the wireless terminal apparatus 2 creates and registers a projector apparatus list 34. Referring to FIG. 20, the projector apparatus list 34 includes projector apparatus identification information, SSIDs, encryption schemes, encryption keys, and field intensities, and the pieces of information are arranged in descending order of field intensity.

FIG. 20 is a table showing an example of the projector apparatus list 34 of the wireless terminal apparatus 2 of FIG. 13. In this case, the SSIDs and the encryption schemes are obtained from probe response frames. In addition, the projector apparatus identification information and the encryption key information are obtained from SSID character strings.

Then, in step S75 of FIG. 18, the wireless terminal apparatus 2 displays a projector apparatus list on the wireless manager, according to the projector apparatus list 34 created in step S74. Referring to FIG. 21, the projector apparatus list is displayed on the display 254 of the wireless terminal apparatus 2 using the projector apparatus identification information. FIG. 21 is a front view showing an example of a projector apparatus selection screen displayed on the display 254 of the wireless terminal apparatus 2 of FIG. 13. Further, in step S76 of FIG. 18, the user selects a single or plurality of projector apparatuses to connect, from the projector apparatus list displayed in step S75. In step S77, the wireless terminal apparatus 2 sets the same SSID, encryption scheme, and encryption key as those of a projector apparatus with a higher field intensity among the projector apparatuses selected in step S76, to the wireless LAN interface 26. In this case, the wireless terminal apparatus 2 sets, as the encryption key, random numbers which are generated using the character string of the SSID as a seed. For example, when the user selects both of the projector apparatus 1a (the projector apparatus identification information is “111a”) and the projector apparatus 1b (the projector apparatus identification information is “222b”), since the projector apparatus 1a has a higher field intensity, the wireless terminal apparatus 2 sets the same SSID and encryption scheme as those of the projector apparatus 1a and generates the same encryption key as that of the projector apparatus 1a. By this, the wireless terminal apparatus 2 participates in a wireless LAN formed by the projector apparatus 1a, and this allows the wireless terminal apparatus 2 to communicate with the projector apparatus 1a. In addition, since the projector apparatus 1a can communicate with the projector apparatus 1b, the wireless terminal apparatus 2 can perform communication with the projector apparatus 1b through the projector apparatus 1a. In step S78, the wireless terminal apparatus 2 is connected to the projector apparatuses at the IP level and starts transmitting image data to the projector apparatus 1a and the projector apparatus 1b.

As described above, each projector apparatus 1 according to the present embodiment operates as an access point apparatus 10 and forms a wireless LAN with a wireless terminal apparatus using, as an SSID, a character string obtained by combining specified network identification information with projector apparatus identification information which varies between individual projector apparatuses. At that time, as an encryption scheme, an encryption scheme with the highest strength in the projector apparatus 1 is set, and as an encryption key, random numbers generated using an SSID character string as a seed are set. After forming the wireless LAN, the projector apparatus 1 transmits a probe request frame for all channels and receives probe response frames which are responses thereto, by which the projector apparatus 1 retrieves the SSIDs of other projector apparatuses 1 present in the communication area (radio wave reaching area) of the projector apparatus, and creates an SSID list and registers information. At that time, the projector apparatus 1 adds to the list the MAC addresses and encryption schemes of the senders which can be obtained from the probe response frames and the field intensities of the senders which can be obtained from the intensities of response radio waves. Thereafter, the projector apparatus 1 searches through the SSID list for SSIDs including the specified network identification information. If detected, then the projector apparatus 1 performs a parity determination. Based on the determination result, the projector apparatus 1 registers the MAC address of the source in a wireless communication list between access point apparatuses. At that time, for an encryption scheme, the projector apparatus 1 compares the encryption strength of an encryption scheme between a projector apparatus 1 to register and a projector apparatus 1 to be registered, and registers the encryption scheme with a lower encryption strength. In addition, for an encryption key, the projector apparatus 1 registers random numbers which are generated using, as a seed, a character string obtained by combining an SSID character string of the projector apparatus 1 to register with an SSID character string of the projector apparatus 1 to be registered. By this, the projector apparatuses 1 operating as the access point apparatuses 10 can be connected to each other.

As such, according to the projector apparatuses 1 according to the present embodiment, by including specified network identification information in the SSID character strings of the projector apparatuses 1, the projector apparatuses 1 can detect a desired projector apparatus 1 from an SSID list created by scanning and can obtain information such as the MAC address of a communication counterpart. Thus, without the need to manually perform settings required for wireless communication between access point apparatuses, the projector apparatuses 1 operating as access point apparatuses 10 can be connected to each other.

It is noted that, although the second embodiment describes the case in which the number of projector apparatuses 1 performing wireless communication between access point apparatuses is two, in the case in which the number of projector apparatuses 1 is three, the process is the same as that for the case of the first embodiment. In addition, four or more projector apparatuses 1 may be provided. Namely, since an encryption scheme is selected and an encryption key is generated for each pair that performs wireless communication between access point apparatuses, when a projector apparatus 1 is added later on to a wireless LAN being formed, the above-described connection process is performed between the added projector apparatus 1 and each of the existing projector apparatuses 1. As such, without manually performing connection settings, a wireless LAN can be extended.

Although in each of the above-described embodiments, in the access point apparatuses 10 (101, 102, and 103), the wireless terminal apparatus 2, and the projector apparatuses 1 (1a and 1b),

(A) a requesting apparatus that transmits a probe request frame and receives a probe response frame and

(B) a responding apparatus that receives a probe request frame and transmits a probe response frame are configured by a single apparatus, the requesting apparatus and the responding apparatus may be separately configured.

In addition, although in each of the above-described embodiments, a wireless LAN is configured by including a plurality of access point apparatuses 101, 102, and 103, for example, a wireless communication system may be configured by including a plurality of wireless communication apparatuses such as the plurality of access point apparatuses 101, 102, and 103.

As mentioned above, the wireless communication apparatus according to the disclosure automates wireless LAN connection settings and establishes a wireless communication connection even in an environment where there is an access point apparatus not belonging to the wireless LAN system, by extracting only the access point apparatus. Thus, the wireless LAN connection settings do not need to be manually performed, and this leads to facilitating wireless LAN connection settings.

Although the disclosure has been fully described in connection with the embodiments thereof with reference to the accompanying drawings, it is to be noted that various changes and modifications are apparent to those skilled in the art. Such changes and modifications are to be understood as included within the scope of the disclosure as defined by the appended claims unless they depart therefrom.

What is claimed is:

1. A wireless communication apparatus for use in a wireless LAN, that performs wireless communication between a plurality of access point apparatuses each having a function of a wireless LAN relay, the wireless communication apparatus comprising:
a network identification information storage unit configured to store predetermined network identification information indicating that the wireless communication apparatus belongs to the wireless LAN;
an access point apparatus information generating unit configured to generate access point apparatus identification information from information unique to an access point apparatus;
an SSID generating unit configured to generate an SSID including the network identification information and the access point apparatus identification information; and
a wireless transmitting and receiving unit configured to receive a probe request signal and transmit a probe response signal including the SSID in response to the probe request signal.

2. The wireless communication apparatus as claimed in claim 1,
wherein the information unique to the access point apparatus is a MAC address assigned to the access point apparatus.

3. The wireless communication apparatus as claimed in claim 1,
wherein the SSID includes the network identification information, the access point apparatus identification information, and a predetermined parity.

4. A wireless communication apparatus for use in a wireless LAN, that performs wireless communication between a plurality of access point apparatuses each having a function of a wireless LAN relay, the wireless communication apparatus comprising:
a network identification information storage unit configured to store predetermined network identification information indicating that the wireless communication apparatus belongs to the wireless LAN;
an access point apparatus information generating unit configured to generate access point apparatus identification information from information unique to an access point apparatus;
an SSID generating unit configured to generate an SSID including the network identification information and the access point apparatus identification information;
a wireless transmitting and receiving unit configured to transmit a probe request signal and receive a probe response signal in response to the probe request signal;
a network identification information detecting unit configured to detect network identification information from the received probe response signal;
a MAC address detecting unit configured to detect a MAC address of a source from the received probe response signal; and
a connection establishing unit configured to establish a wireless communication connection with a wireless communication apparatus being the source of the probe response signal.

5. The wireless communication apparatus as claimed in claim 4,
wherein the information unique to the access point apparatus is a MAC address assigned to the access point apparatus.

6. The wireless communication apparatus as claimed in claim 4,
wherein the SSID includes the network identification information, the access point apparatus identification information, and a predetermined parity.

7. The wireless communication apparatus as claimed in claim 4,
wherein the connection establishing unit generates an encryption key based on the access point apparatus identification information, and establishes a wireless communication connection with the wireless communication apparatus being the source of the probe response signal, using the generated encryption key.

8. A wireless communication apparatus for use in a wireless LAN, that performs wireless communication between a plurality of access point apparatuses each having a function of a wireless LAN relay, the wireless communication apparatus comprising:
a network identification information storage unit configured to store predetermined network identification information indicating that the wireless communication apparatus belongs to the wireless LAN;
an access point apparatus information generating unit configured to generate access point apparatus identification information from information unique to an access point apparatus;
an SSID generating unit configured to generate an SSID including the network identification information and the access point apparatus identification information;
a wireless transmitting and receiving unit configured to receive a probe request signal and transmit a probe response signal including the SSID in response to the probe request signal, and transmit a probe request signal and receive a probe response signal in response to the probe request signal;
a network identification information detecting unit configured to detect network identification information from the received probe response signal;
a MAC address detecting unit configured to detect a MAC address of a source from the received probe response signal; and
a connection establishing unit configured to establish a wireless communication connection with a wireless communication apparatus being the source of the probe response signal.

9. The wireless communication apparatus as claimed in claim 8,
wherein the information unique to the access point apparatus is a MAC address assigned to the access point apparatus.

10. The wireless communication apparatus as claimed in claim 8,
wherein the SSID includes the network identification information, the access point apparatus identification information, and a predetermined parity.

11. The wireless communication apparatus as claimed in claim 8,
wherein the connection establishing unit generates an encryption key based on the access point apparatus identification information, and establishes a wireless communication connection with the wireless communication apparatus being the source of the probe response signal, using the generated encryption key.

12. A projector apparatus comprising:
an optical projector unit configured to enlarge and project an image of received image data; and
a wireless communication apparatus for use in a wireless LAN, the wireless communication apparatus performing wireless communication between a plurality of access point apparatuses each having a function of a wireless LAN relay,
wherein the wireless communication apparatus comprises:
a network identification information storage unit configured to store predetermined network identification information indicating that the wireless communication apparatus belongs to the wireless LAN;
an access point apparatus information generating unit configured to generate access point apparatus identification information from information unique to an access point apparatus;
an SSID generating unit configured to generate an SSID including the network identification information and the access point apparatus identification information; and
a wireless transmitting and receiving unit configured to receive a probe request signal and transmit a probe response signal including the SSID in response to the probe request signal.

13. A projector apparatus comprising:
an optical projector unit configured to enlarge and project an image of received image data; and
a wireless communication apparatus for use in a wireless LAN, the wireless communication apparatus performing wireless communication between a plurality of access point apparatuses each having a function of a wireless LAN relay,
wherein the wireless communication apparatus comprises:
a network identification information storage unit configured to store predetermined network identification information indicating that the wireless communication apparatus belongs to the wireless LAN;
an access point apparatus information generating unit configured to generate access point apparatus identification information from information unique to an access point apparatus;
an SSID generating unit configured to generate an SSID including the network identification information and the access point apparatus identification information;
a wireless transmitting and receiving unit configured to transmit a probe request signal and receive a probe response signal in response to the probe request signal;
a network identification information detecting unit configured to detect network identification information from the received probe response signal;
a MAC address detecting unit configured to detect a MAC address of a source from the received probe response signal; and
a connection establishing unit configured to establish a wireless communication connection with a wireless communication apparatus being the source of the probe response signal.

14. A projector apparatus comprising:
an optical projector unit configured to enlarge and project an image of received image data; and
a wireless communication apparatus for use in a wireless LAN, the wireless communication apparatus performing wireless communication between a plurality of access point apparatuses each having a function of a wireless LAN relay,
wherein the wireless communication apparatus comprises:
a network identification information storage unit configured to store predetermined network identification information indicating that the wireless communication apparatus belongs to the wireless LAN;
an access point apparatus information generating unit configured to generate access point apparatus identification information from information unique to an access point apparatus;
an SSID generating unit configured to generate an SSID including the network identification information and the access point apparatus identification information;
a wireless transmitting and receiving unit configured to receive a probe request signal and transmit a probe response signal including the SSID in response to the probe request signal, and transmit a probe request signal and receive a probe response signal in response to the probe request signal;
a network identification information detecting unit configured to detect network identification information from the received probe response signal;
a MAC address detecting unit configured to detect a MAC address of a source from the received probe response signal; and
a connection establishing unit configured to establish a wireless communication connection with a wireless communication apparatus being the source of the probe response signal.

15. A wireless communication system comprising a plurality of wireless communication apparatuses,
wherein each of the wireless communication apparatuses is for use in a wireless LAN, and performs wireless communication between a plurality of access point apparatuses each having a function of a wireless LAN relay, and
wherein each of the wireless communication apparatuses comprises:
a network identification information storage unit configured to store predetermined network identification information indicating that the wireless communication apparatus belongs to the wireless LAN;
an access point apparatus information generating unit configured to generate access point apparatus identification information from information unique to an access point apparatus;
an SSID generating unit configured to generate an SSID including the network identification information and the access point apparatus identification information; and
a wireless transmitting and receiving unit configured to receive a probe request signal and transmit a probe response signal including the SSID in response to the probe request signal.

16. A wireless communication system comprising a plurality of wireless communication apparatuses,
wherein each of the wireless communication apparatuses is for use in a wireless LAN, that performs wireless communication between a plurality of access point apparatuses each having a function of a wireless LAN relay, and
wherein each of the wireless communication apparatuses comprises:
a network identification information storage unit configured to store predetermined network identification information indicating that the wireless communication apparatus belongs to the wireless LAN;
an access point apparatus information generating unit configured to generate access point apparatus identification information from information unique to an access point apparatus;
an SSID generating unit configured to generate an SSID including the network identification information and the access point apparatus identification information;
a wireless transmitting and receiving unit configured to transmit a probe request signal and receive a probe response signal in response to the probe request signal;
a network identification information detecting unit configured to detect network identification information from the received probe response signal;
a MAC address detecting unit configured to detect a MAC address of a source from the received probe response signal; and
a connection establishing unit configured to establish a wireless communication connection with a wireless communication apparatus being the source of the probe response signal.

17. A wireless communication system comprising a plurality of wireless communication apparatuses,
wherein each of the wireless communication apparatuses is for use in a wireless LAN, that performs wireless communication between a plurality of access point apparatuses each having a function of a wireless LAN relay, and
wherein each of the wireless communication apparatuses comprises:
a network identification information storage unit configured to store predetermined network identification information indicating that the wireless communication apparatus belongs to the wireless LAN;
an access point apparatus information generating unit configured to generate access point apparatus identification information from information unique to an access point apparatus;
an SSID generating unit configured to generate an SSID including the network identification information and the access point apparatus identification information;
a wireless transmitting and receiving unit configured to receive a probe request signal and transmit a probe response signal including the SSID in response to the probe request signal, and transmit a probe request signal and receive a probe response signal in response to the probe request signal;
a network identification information detecting unit configured to detect network identification information from the received probe response signal;
a MAC address detecting unit configured to detect a MAC address of a source from the received probe response signal; and
a connection establishing unit configured to establish a wireless communication connection with a wireless communication apparatus being the source of the probe response signal.

18. A wireless communication method for use in a wireless LAN, that performs wireless communication between a plurality of access point apparatuses each having a function of a wireless LAN relay, the wireless communication method comprising the steps of:
storing predetermined network identification information indicating belonging to the wireless LAN, in a storage apparatus;
generating access point apparatus identification information from information unique to an access point apparatus;
generating an SSID including the network identification information and the access point apparatus identification information; and
receiving a probe request signal and transmitting a probe response signal including the SSID in response to the probe request signal.

19. A wireless communication method for use in a wireless LAN, that performs wireless communication between a plurality of access point apparatuses each having a function of a wireless LAN relay, the wireless communication method comprising the steps of:
storing predetermined network identification information indicating belonging to the wireless LAN, in a storage apparatus;
generating access point apparatus identification information from information unique to an access point apparatus;
generating an SSID including the network identification information and the access point apparatus identification information;
transmitting a probe request signal and receiving a probe response signal in response to the probe request signal;
detecting network identification information from the received probe response signal;
detecting a MAC address of a source from the received probe response signal; and
establishing a wireless communication connection with a wireless communication apparatus being the source of the probe response signal.

20. A wireless communication method for use in a wireless LAN, that performs wireless communication between a plurality of access point apparatuses each having a function of a wireless LAN relay, the wireless communication method comprising the steps of:
storing predetermined network identification information indicating belonging to the wireless LAN;
generating access point apparatus identification information from information unique to an access point apparatus;
generating an SSID including the network identification information and the access point apparatus identification information;
receiving a probe request signal and transmitting a probe response signal including the SSID in response to the probe request signal, and transmitting a probe request signal and receiving a probe response signal in response to the probe request signal;
detecting network identification information from the received probe response signal;
detecting a MAC address of a source from the received probe response signal; and
establishing a wireless communication connection with a wireless communication apparatus being the source of the probe response signal.
